(19) United States
(12) Patent Application Publication
(10) Pub. No.: US 2007/0140532 A1
(43) Pub. Date: Jun. 21, 2007

(54) Method and apparatus for providing user profiling based on facial recognition

(76) Inventor: Glen P. Goffin, Dublin, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/312,220

(22) Filed: Dec. 20, 2005

(51) Int. Cl. G06K 9/00

(52) U.S. Cl. 382/118; 340/5.53; 726/26

(57) ABSTRACT

A method and system of providing user profiling for an electrical device is disclosed. Face representation data is captured with an imaging device. The imaging device focuses on the face of the user to capture the face representation data. A determination is made as to whether a facial feature database includes user facial feature data that matches the face representation data. User preference data is loaded on a memory module of the electrical device when the face representation data matches user facial feature data in the facial feature database. A new user profile is added to the user profile database when the face representation data does not match user facial feature data in the facial feature database.

### BACKGROUND

1. Field of the Disclosure

The present disclosure relates to user profiling, recognition, and authentication. In particular, it relates to user profiling, recognition, and authentication using videophone systems or image capturing devices.

2. General Background

Audiovisual conferencing capabilities are generally implemented using computer based systems, such as in personal computers (“PCs”) or videophones. Some videophones and other videoconferencing systems offer the capability of storing user preferences. Generally, user preferences in videophones and other electronic devices are set up such that the preferences set by the last user are the preferences being utilized by the videophone or electronic device. In addition, these systems typically require substantial interaction by the user. Such interaction may be burdensome and time-consuming.

Furthermore, images captured by cameras in videophones are simply transmitted over a videoconferencing network to the destination videophone. As such, user facial expressions and features are not recorded for any other purpose than for transmission to the other videoconferencing parties. Finally, current videophones and other electrical devices only permit setting up user preferences for a single user.

### SUMMARY

A method and system of providing user profiling for an electrical device is disclosed. Face representation data is captured with an imaging device. The imaging device focuses on the face of the user to capture the face representation data. A determination is made as to whether a facial feature database includes user facial feature data that matches the face representation data. User preference data is loaded on a memory module of the electrical device when the face representation data matches user facial feature data in the facial feature database. A new user profile is added to the user profile database when the face representation data does not match user facial feature data in the facial feature database.

A user profiling system that includes a facial recognition module, a facial feature database, a user profiling module, and a user profiling database. The facial recognition module receives face representation data, the face representation data being captured by an imaging device. The imaging device focuses on the face of the user to capture the face representation data. The facial feature database stores a plurality of user records, each of the plurality of user records storing face representation data. In addition, each of the plurality of user records may correspond to each of a plurality of users of an electrical device. The user profiling module loads user preference data on a memory module of the electrical device. The user preference data is loaded on the electrical device when the face representation data matches user facial feature data in the facial feature database. The user profiling module creates a new user profile when the face representation data does not match user facial feature data in the facial feature database. Finally, the user profiling database stores a plurality of user profiles and corresponding user preference data, the user profiles corresponding to each of the plurality of users of the electrical device.

### BRIEF DESCRIPTION OF THE DRAWINGS

By way of example, reference will now be made to the accompanying drawings.

FIG. 1 illustrates a videophone imaging a human face.

FIG. 2 illustrates components and peripheral devices of a facial recognition and profiling unit.

FIG. 3 illustrates a flowchart for a process for facial recognition and user profiling based facial recognition.

FIGS. 4A-4C illustrate examples of electronic devices that may be coupled with the facial recognition and profiling unit.

FIG. 5 illustrates a personal data assistant interacting with the facial recognition and profiling unit over a computer network.

FIG. 6 illustrates a block diagram of a facial recognition and profiling system.

### DETAILED DESCRIPTION

A method and apparatus for automated facial recognition and user profiling is disclosed. The system and method may be applied to one or more electrical systems that provide the option of setting up customized preferences. These systems may be personal computers, telephones, videophones, automated teller machines, personal data assistants, media players, and others.

Electrical systems do not generally store and manage settings and user-specific information or multiple users. Rather, current systems provide user interfaces with limited interfacing capabilities. The method and apparatus disclosed herein automatically maintain preferences and settings for multiple users based on facial recognition. Unlike current systems which are cumbersome to operate and maintain, the system and method disclosed herein automatically generate users preferences, and settings based on user actions, commands, order of accessing information, etc. Once a facial recognition module recognizes a returning user's face, a user-profiling module may collect user specific actions generate and learn user preferences for the returning user. If the user is not recognized by the facial recognition module, a new profile may be created and settings, attributes, preferences, etc., may be stored as part of the new user's profile.

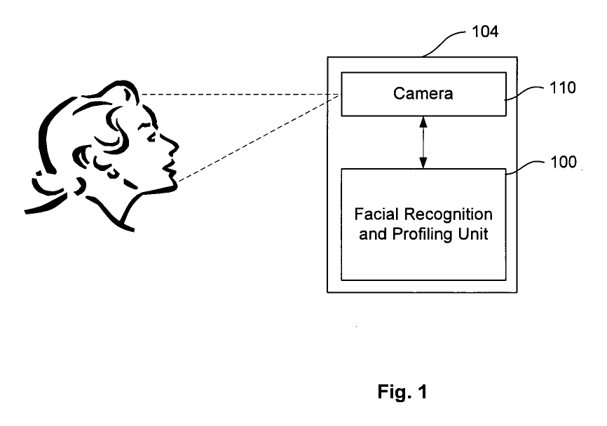

FIG. 1 illustrates a videophone imaging a human face. A videophone 104 utilizing a camera 110 and a facial recognition and profiling unit 100 may be configured to capture the users face, facial expressions, and other facial characteristics that may uniquely identify the user. The facial recognition and profiling unit 100 receives a captured image from the camera 110, and saves the data representing the user's face. In one embodiment, the camera 110, and the facial recognition and profiling unit 100 are housed within the videophone 104. In another embodiment, the camera 110, and the facial recognition and profiling unit 100 are housed in separate housings the videophone 104.

In one example, the videophone 102 captures the face of the user only when the user is in a videoconference communicating with other videophone users. Thus, video recognition and profiling are performed without disturbing the user's videoconferencing session. Thus, the recognition and profiling are processes that are transparently carried out with respect to the user. While the user is on a videoconference, the facial recognition and profiling unit 100 may generate user preference and setting based on the user actions. In another embodiment, the videophone 102 captures the face of the user when the user is operating the videophone 102, and not necessarily during a videoconference. As such, the facial recognition and profiling unit 100 collects user action and behavior data to corresponding to any interaction between the user the videophone 102.

For example, during a videoconference call the user may set the volume at a certain level. This action is recorded by the facial recognition and profiling unit 100 and associated with the user's profile. Then, when the user returns to make another videoconference call, the user's face is recognized by the facial recognition and profiling unit 100, and the volume is automatically set to the level at which the user set it on the previous conference call.

In another example, during a videoconference call, both the near-end caller and the far-end caller is recognized by the facial recognition and profiling unit 100. The near-end user may be a user that has been recognized in the past by the facial recognition and profiling unit 100. When the near-end user receives a call from an far-end caller, the facial recognition and profiling unit 100 searches for the far-end caller profile and load the near-end user preferences with respect to communication with the far-end user. In addition, the far-end caller preferences and data may also be load for quick retrieval or access by the facial recognition and profiling unit 100. The facial recognition and profiling unit 100 may be configured to load any number of user profiles that may be parties of a conference call. The profiles, data and other associated information to the users participating in the conference call may or may not be available to other users in the conference call, depending on security settings, etc.

In yet another example, the outgoing videophone call log may be recorded for each user. The contact information for the parties in communication with each user is automatically saved. When the user returns to engage in another video conference call, the contact information for all of the contacted parties in the call log may be automatically loaded. In one embodiment, the facial recognition and profiling unit 100 stores user profiles for multiple users. Thus, if a second user engages in a video conference call at the same videophone 100, the videophone 100 may recognize the second user's face, and immediately load the contact list pertinent to the second user. As such, by performing facial recognition and automatically generating user profiles, minimal user interaction is required.

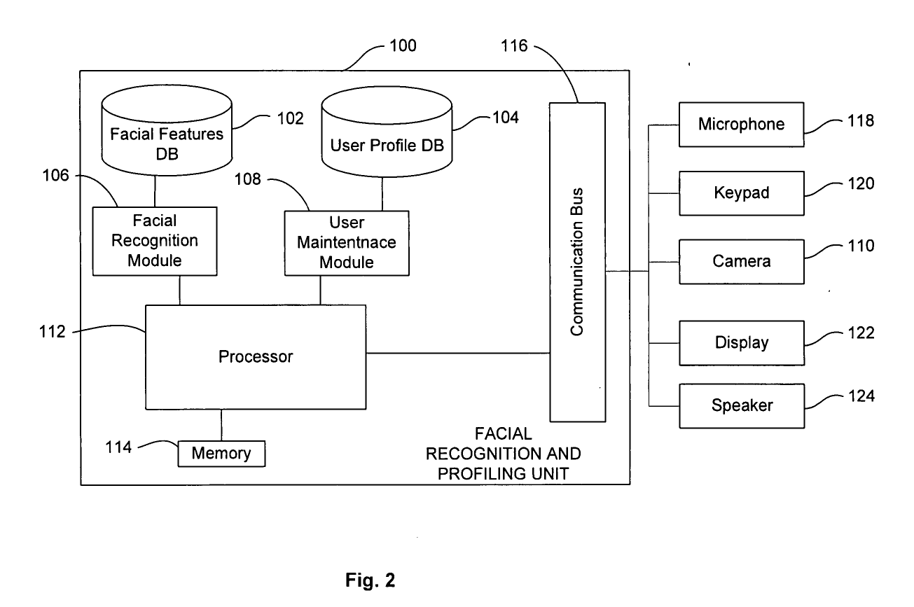

FIG. 2 illustrates components and peripheral devices of a facial recognition and profiling unit. The facial recognition and profiling unit 100 may include a facial features database 102, a user profile database 104, a facial recognition module 106, a user maintenance module 108, a processor 112, and a random access memory 114.

The facial features database 102 may store facial feature data for each user in the user profile database 104. In one embodiment, each user has multiple associated facial features. In another embodiment, each user has a facial feature image stored in the facial features database 102. The facial recognition module 106 includes logic to store the facial features associated with each user. In one embodiment, the logic includes a comparison of the facial features of a user with the facial features captured by the camera 110. If a threshold of similarity is surpassed by a predefined number of facial features, then the captured face is authenticated as belonging to the user associated with the facial features deemed similar to the captured face. In another embodiment, if a threshold of similarity is surpassed by at least one facial feature, then the captured face is authenticated as being the user associated with the facial feature deemed similar to the facial features in the user's face. In another embodiment, the facial recognition module 106 includes logic that operates based template matching algorithms. Pre-established templates for each may be configured as part of the recognition module 106 and a comparison be made to determined the difference percentage.

A new user, and associated facial features and characteristics may be added if the user is not recognized as an existing user. In one embodiment, if a threshold of similarity is not surpassed by a predefined number of facial features, then the captured face is added as a new user with the newly captured facial characteristics. In another embodiment, if a threshold of similarity is surpassed by at least one facial feature, then the captured face is added as a new user with the newly captured facial characteristics.

In one example, the facial recognition module 106 stores images for five facial features of the user (e.g. eyes, nose, mouth, and chin) in the facial features database 102. In another example, the facial recognition module 106 stores measurements of each of the facial features of a user. In yet another example, the facial recognition module 106 stores blueprints of each of the facial features of a user. In another example, the facial recognition module 106 stores a single image of the user's face. In another example, the facial recognition module 106 stores new facial feature data if the user is a new user. One or more pre-existing facial recognition schemes may be used to perform facial recognition.

The user profile database 104 may store user preferences, alternative identification codes, pre-defined commands, and other user-specific data. The user maintenance module 108 includes logic to perform user profiling. In one embodiment, the maintenance module includes logic to extract a user profile based on a user identifier. The user identifier may be, for example, the user facial features stored in the facial features database 102. In another embodiment, the maintenance module 108 includes logic to save user settings under the user's profile. In another embodiment, the maintenance module 108 includes logic to interpret user operations as a user preference and save the user preference under the user's profile. In another embodiment, the maintenance module 108 includes logic to interpret user operations as a user preference and save the user preference under the user's profile. In yet another embodiment, the maintenance module 108 includes logic to add a new user if the user is not associated with an existing user profile.

The facial recognition and profiling unit 100 may be connected to one or more peripheral devices for input and output. For example, a camera 110 is coupled with the facial recognition and profiling unit through a communications bus 116. The camera 110 captures the face of a person and generates an image of the user's face. In one embodiment, the camera 110 streams a captured data to the facial recognition module 104 without any presorting or pre-processing the images captured. In another embodiment, the camera 110 is configured to only transmit to the facial recognition module 106 images that resemble a human face. In another example, a keypad 120, a microphone 118, a display 122 and a speaker 124 is connected to the facial recognition and profiling unit 100 via the communications bus 116. Various other input and output devices may be in communication with the facial recognition and profiling unit 100. The inputs form various input devices may be utilized to monitor and learn user behavior and preferences.

In one embodiment, the facial recognition and profiling unit 100 is separated into two components in two separate housings. The facial recognition module 106 and the facial features database 102 is housed in a first housing. The user profile database 104 and the user maintenance module 108 may be housed in the second housing.

In one embodiment, facial recognition entails receiving a captured image of a user's face, for example through the camera 110, and verifying that the provided image corresponds to an authorized user by searching the provided image in the facial features database 102. If the user is not recognized, the user is added as a new user based on the captured faced characteristics. The determination of whether the facial features in the captured image correspond to facial features of an existing user in the facial features database 102 is performed by the facial recognition module 106. As previously stated, the facial recognition module 106 may include operating logic for comparing the captured user's face with the facial feature data representing an authorized user's faces stored in facial features database 102. In one embodiment, the facial features database 102 includes a relational database that includes facial feature data for each of the users profiled in the user profile database 104. In another embodiment, the facial features database 102 may be a read only memory (ROM) lookup table for storing data representative of an authorized user's face.

Furthermore, user profiling may be performed by a user maintenance module 108. In another embodiment, the user profile database 104 is a read-only memory in which user preferences, pre-configured function commands, associated permissions, etc. are stored. For example, settings such as preview inset turned on/off, user interface preferences, ring-tone preferences, call history logs, phonebook and contact lists, buddy list records, preferred icons, preferred emoticons, chat-room history logs, email addresses, schedules, etc. The user maintenance module 108 retrieves and stores data on the user profile database 104 to update the pre-configured commands, preferences, etc. As stated above, the user maintenance module 108 includes operating logic to determine user actions that are included in the user profile.

In addition, the facial recognition and profiling unit 100 includes a computer processor 112, which exchanges data with the facial recognition module 106 and the user maintenance module 108. The computer processor 112 executes operations such as comparing incoming images through the facial recognition module 106, and requesting user preferences, profile and other data associated with an existing user through the user maintenance module 108.

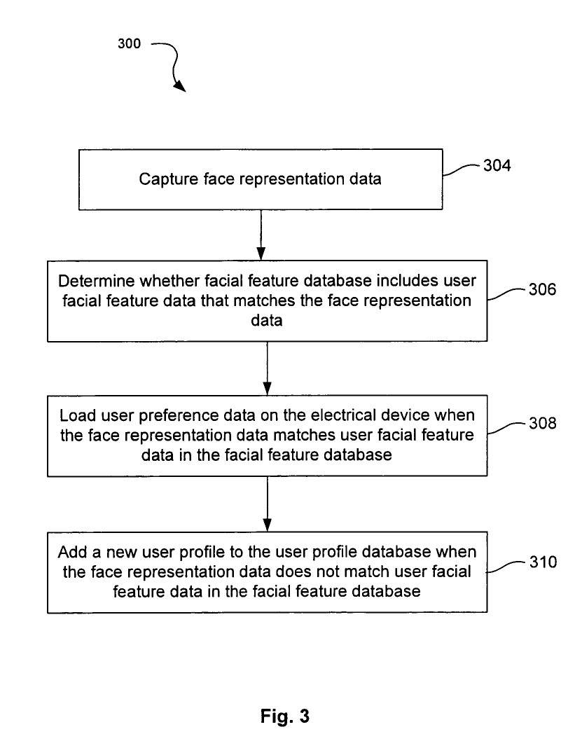

FIG. 3 illustrates a flowchart for a process for facial recognition and user profiling based facial recognition. In one embodiment, the process is performed by the facial recognition and profiling unit 100. Process 300 starts at process block 304 wherein the camera 110 captures an image of the user's face. In one embodiment, at process block 304, the user's face has been captured by facial recognition module 106 which is configured to discard any incoming images that are not recognized as a human face shape. In one embodiment, the camera 100 only captures the image of the user's face if the camera 110 detects an object in the camera's 110 vicinity. In one embodiment, the camera 110 is configured to detect if a shape similar to a face is being focused by the camera 110. In another embodiment, the camera 110 forwards all the captured data to the facial recognition module 106 wherein the determination of whether a face is being detected is made. The process 300 then continues to process block 306.

At process block 306, data representing the image of the scanned face is compared against the facial feature data stored in the facial features database 102 according to logic configured in the facial recognition module 106. As such, at decision process block 306 a determination is made whether the data representing the image of the scanned face matches facial feature data representing stored the facial feature database 102. The process 300 then continues to process block 308.

At process block 308, if the data representing the image of the scanned face matches data representing an image of at least one reference facial feature stored the facial feature database 102 user preferences are loaded on the electrical device. In one embodiment, a determination is made as to whether or not there are user preferences pre-set and stored in the user profiled database 102. If there are user preferences already in place, then the user profile and corresponding preferences are loaded on the electrical device. In another embodiment, if there are no pre-established user preferences, the user subsequent requests, actions, commands and input are collected in order to generate and maintain the user profile. In one embodiment, user preferences are automatically generated. Facial expressions, actions, commands, etc., corresponding to recognized user faces are automatically collected and stored in a user profile database. The data stored for each user may include call history logs, user data, user contact information, and other information learned while the user is using the videophone. User profiles may be generated without the need for user interaction. The process 300 then continues to process block 310.

At process block 310, if the data representing the image of the scanned face does not match data representing an image of at least one reference facial feature stored the facial feature database 102 the user is added as a new user to the user profile database 104. Facial features data representing the user's face are added to the facial feature database 102. In addition, the user profile database 104 includes a new record that may be keyed based on the user's face or facial features. Thus, every time a new user is added, a new record with associated facial features and preferences is created. Multiple users may access the system and establish a user account based on user-specific facial features.

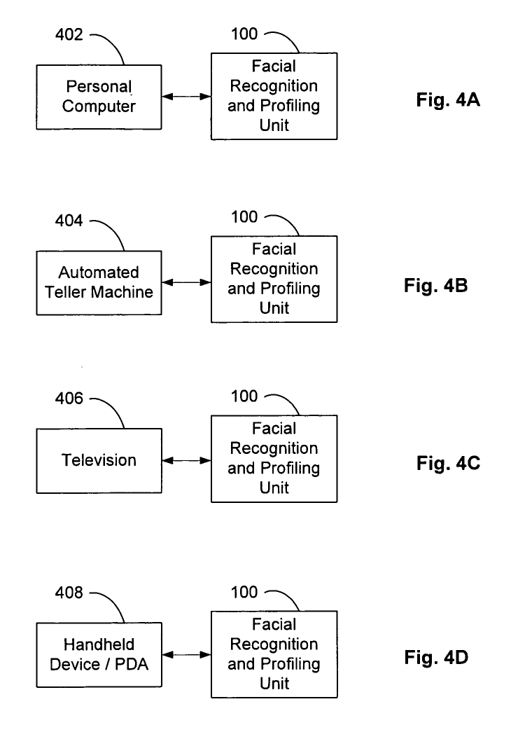

FIGS. 4A, 4B, 4C and 4D illustrate examples of electronic devices that may be coupled with the facial recognition and profiling unit 100. In one embodiment, the facial recognition and profiling unit 100 is incorporated into the electronic device such that the components are in the same housing. In another embodiment, the facial recognition and profiling unit 100 is provided in a separate housing from the electronic device.

FIG. 4A illustrates a personal computer 402 interacting with the facial recognition and profiling unit 100. The personal computer 402 may be operated depending on different configurations established by the facial recognition and profiling unit 100. In one embodiment, the personal computer includes a camera 110 that feeds an image of the captured face or facial features of each user of the personal computer. As explained above, a user profile may be generated and stored based on a user's face or facial features. As the user interacts with the personal computer 402, the new settings, preferences, and other user-specific data are learned, generated and stored by the facial recognition and profiling unit 100. In future interactions with the personal computer 402, the facial recognition and profiling unit 100 will retrieve user preferences and load them for interaction with the recognized user. For example, font size, wallpaper image, preferred Internet download folder, etc., be loaded and provided by the personal computer 402 once a user is recognized and preference parameters are loaded.

FIG. 4B illustrates an automated teller machine 404 interacting with the facial recognition and profiling unit 100. The automated teller machine 404 may be operated depending on different configurations established by the facial recognition and profiling unit 100. In one embodiment, the automated teller machine 404 includes a camera 110 that feeds an image of the captured face or facial features of each user of the automated teller machine 404. As explained above, a user profile may be generated and stored based on a user's face or facial features. As the user interacts with the automated teller machine 404 the new settings, preferences, and other user-specific data are learned, generated and stored by the facial recognition and profiling unit 100. In future interactions with the automated teller machine 404, the facial recognition and profiling unit 100 may retrieve user preferences and load them for interaction with the recognized user. For example, display font size, voice activation, frequently used menu items, etc., is loaded and provided by the automated teller machine 404 once a user is recognized and preference parameters are loaded.

FIG. 4C illustrates a television unit 406 interacting with the facial recognition and profiling unit 100. The television unit 406 may be operated depending on different configurations established by the facial recognition and profiling unit 100. In one embodiment, the television unit 406 includes a camera 110 that feeds an image of the captured face or facial features of each user of the television unit 406. As explained above, a user profile is generated and stored based on a user's face or facial features. As the user interacts with the television unit 406, the new settings, preferences, and other user-specific data are learned, generated and stored by the facial recognition and profiling unit 100. In future interactions with the television unit 406, the facial recognition and profiling unit 100 may retrieve user preferences and load them for interaction with the recognized user. For example, favorite channels, sound preference, color, contrast, preferred volume level, etc., may be loaded and provided by the television unit 406 once a user is recognized and preference parameters are loaded.

FIG. 4D illustrates a personal data assistant 408 interacting with the facial recognition and profiling unit 100. The personal data assistant 408 may be operated depending on different configurations established by the facial recognition and profiling unit 100. In one embodiment, the personal data assistant 408 includes a camera 110 that feeds an image of the captured face or facial features of each user of the personal data assistant 408. As explained above, a user profile may be generated and stored based on a user's face or facial features. As the user interacts with the personal data assistant 408 the new settings, preferences, and other user-specific data are learned, generated and stored by the facial recognition and profiling unit 100. In future interactions with the personal data assistant 408, the facial recognition and profiling unit 100 may retrieve user preferences and load them for interaction with the recognized user. For example, font size, wallpaper image, and preferred Internet download folder may be loaded and provided by the personal data assistant 408 once a user is recognized and preference parameters are loaded.

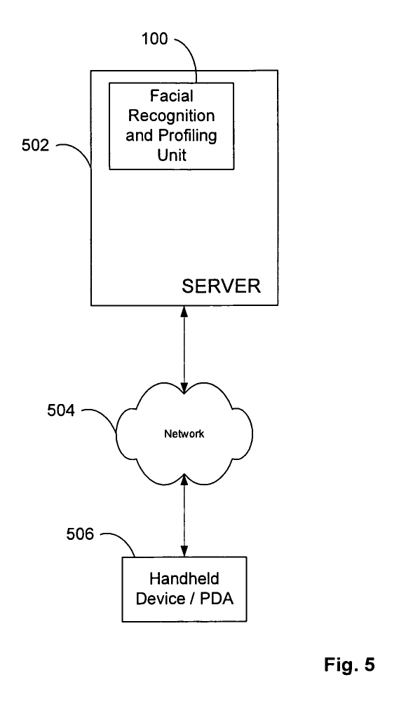

FIG. 5 illustrates a personal data assistant 502 interacting with the facial recognition and profiling unit over a computer network. In one embodiment, the facial recognition and profiling unit 100 is located at a server 504. The facial recognition and profiling unit 100 communicates with the server 504 through a network 210 such as a Local Area Network (“LAN”), a Wide Area Network (“WAN”), the Internet, cable, satellite, etc. The personal data assistant 502 may have incorporated an imaging device such as a camera 110. In another embodiment, the camera 100 is connected to the personal data assistant but it is not integrated under the same housing.

The personal data assistant 502 may communicate with the facial recognition and profiling unit 100 to provide user facial features, user operations, and other data as discussed above. In addition, the facial recognition and profiling unit 100 stores user profiles, recognize new and existing user facial features, and exchange other data with the personal data assistant 502.

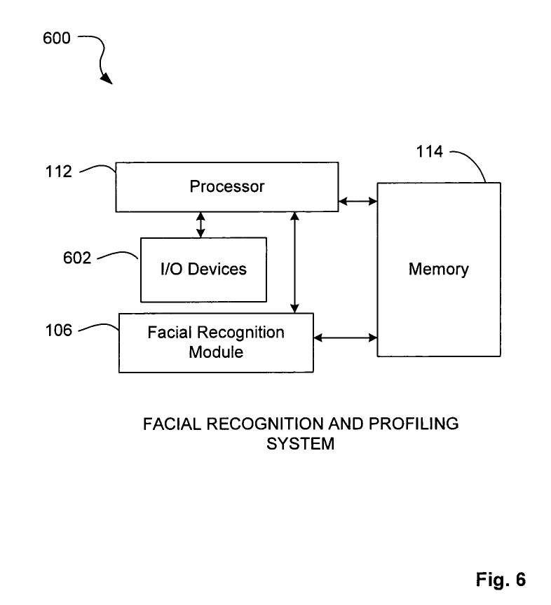

FIG. 6 illustrates a block diagram of a facial recognition and profiling system 600. Specifically, the facial recognition and profiling system 600 may be employed to automatically generate users profiles and settings based on user actions, commands, order of accessing information, etc., utilizing facial recognition to distinguish among users. In one embodiment, facial recognition and profiling system 600 is implemented using a general-purpose computer or any other hardware equivalents.

Thus, the facial recognition and profiling system 600 comprises processor (CPU) 112, memory 114, e.g., random access memory (RAM) and/or read only memory (ROM), facial recognition module 106, and various input/output devices 602, (e.g., storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)).

It should be understood that the facial recognition module 106 may be implemented as one or more physical devices that are coupled to the processor 112 through a communication channel. Alternatively, the facial recognition module 106 may be represented by one or more software applications (or even a combination of software and hardware, e.g., using application specific integrated circuits (ASIC)), where the software is loaded from a storage medium, (e.g., a magnetic or optical drive or diskette) and operated by the processor 112 in the memory 114 of the facial recognition and profiling system 600. As such, the facial recognition module 106 (including associated data structures) of the present invention may be stored on a computer readable medium, e.g., RAM memory, magnetic or optical drive or diskette and the like.

Although certain illustrative embodiments and methods have been disclosed herein, it will be apparent form the foregoing disclosure to those skilled in the art that variations and modifications of such embodiments and methods may be made without departing from the true spirit and scope of the art disclosed. Many other examples of the art disclosed exist, each differing from others in matters of detail only. Accordingly, it is intended that the art disclosed shall be limited only to the extent required by the appended claims and the rules and principles of applicable law.

1. A method of providing user profiling for an electrical device, comprising:
capturing face representation data with an imaging device, wherein the imaging device focuses on the face of the user to capture the face representation data;
determining whether a facial feature database includes user facial feature data that matches the face representation data;
loading user preference data on the electrical device when the face representation data matches user facial feature data in the facial feature database; and
adding a new user profile to the user profile database when the face representation data does not match user facial feature data in the facial feature database.

2. The method of claim 1, further comprising storing new user preference data in the new user profile based on user interaction with the electrical device.

3. The method of claim 1, further comprising storing new user history data in the new user profile based on user interaction with the electrical device.

4. The method of claim 1, further comprising locating in the user profile database an existing user profile corresponding to the matching user facial feature data.

5. The method of claim 1, wherein loading user preference data on the electrical device comprises loading user existing facial feature data existing on a memory module of electrical device.

6. The method of claim 1, wherein determining whether the facial feature database includes user facial feature data that matches the face representation data is performed by a facial recognition module in the electrical device.

7. The method of claim 1, wherein the user preference data and the history data is stored in the user profile database.

8. The method of claim 1, wherein the new user profile added to the user profile database is uniquely identifiable based on the face representation data.

9. The method of claim 1, wherein the user preference data includes sound preference, color preferences, or video preferences.

10. The method of claim 1, wherein the electrical device is a videophone, a personal computer, a personal data assistant, or a camera.

11. A user profiling system, comprising:
a facial recognition module that receives face representation data, the face representation data being captured by an imaging device, wherein the imaging device focuses on the face of the user to capture the face representation data;
a facial feature database that stores a plurality of user records, each of the plurality of user records storing face representation data, wherein each of the plurality of user records corresponds to each of a plurality of users of an electrical device;
a user profiling module that loads user preference data on the electrical device, the user preference data being loaded on the memory module of the electrical device when the face representation data matches user facial feature data in the facial feature database, wherein the user profiling module creates a new user profile when the face representation data does not match user facial feature data in the facial feature database; and
a user profiling database that stores a plurality of user profiles and corresponding user preference data, the user profiles corresponding to each of the plurality of users of the electrical device.

12. The user profiling system of claim 11, wherein a new user preference data is stored in the new user profile based on user interaction with the electrical device.

13. The user profiling system of claim 11, wherein a new user history data is stored in the new user profile based on user interaction with the electrical device.

14. The user profiling system of claim 11, wherein an existing user profile corresponding to the matching user facial feature data can be located in the user profile database.

15. The user profiling system of claim 11, wherein user preference data loaded on the electrical device corresponds to existing user facial feature data, the existing user facial feature data begin loaded on a memory module of the electrical device.

16. The user profiling system of claim 11, wherein a facial recognition module in the electrical device determines whether the facial feature database includes user facial feature data that matches the face representation data.

17. The user profiling system of claim 11, wherein the user preference data and the history data is stored in the user profile database.

18. The user profiling system of claim 11, wherein the new user profile added to the user profile database is uniquely identifiable based on the face representation data.

19. The user profiling system of claim 11, wherein the user preference data includes sound preference, color preferences, or video preferences.

20. The user profiling system of claim 11, wherein the electrical device is a videophone, a personal computer, a personal data assistant, or a camera.
